(19) United States
(12) Patent Application Publication
(10) Pub. No.: US 2024/0369433 A1
(43) Pub. Date: Nov. 7, 2024

(54) Metal Pressure Measuring Cell

(71) Applicant: HUBA CONTROL AG, Würenlos (CH)

(72) Inventors: Jürg Hess, Hägglingen (CH); Frédéric Zimmermann, Zürich (CH); Jonas Müller, Wettingen (CH); Raphael Käppeli, Mellingen (CH)

(21) Appl. No.: 18/687,341

(22) PCT Filed: Aug. 29, 2022
(86) PCT No.: PCT/EP2022/073971

§ 371 Date: Feb. 28, 2024

(30) Foreign Application Priority Data
Aug. 31, 2021 (CH) CH070225/2021

(51) Int. Cl. G01L 13/02; G01L 19/14

(52) U.S. Cl. CPC G01L 13/025; G01L 19/147

(57) ABSTRACT

A metal pressure measuring cell for absolute pressure sensing is described, including a metal base body with a membrane and a support body. The membrane includes a first surface and a second surface. The support body includes a cavity which is transversely delimited by an inner surface of the support body and axially delimited at a first side by the first surface of the membrane and open at a second side opposite to the first side to form a trough-shaped chamber for accommodating a measurement medium. The pressure measuring cell further includes a cap mounted on the base body and covering the second surface of the membrane such that a hermetically closed pressure reference volume is formed between the cap and the second surface of the membrane, wherein the cap is made of metal.

### CROSS-REFERENCE TO RELATED APPLICATIONS

This application is the United States national phase of International Application No. PCT/EP2022/073971 filed Aug. 29, 2022, and claims priority to Swiss Patent Application No. CH070225/2021 filed Aug. 31, 2021, the disclosures of each of which are hereby incorporated by reference in their entireties.

### BACKGROUND OF THE INVENTION

### Field of the Invention

The present invention relates to an absolute pressure measuring cell made of metal, a pressure transducer comprising a pressure measuring cell and a dosing unit for dosing an exhaust gas reduction medium, comprising a pressure transducer, and a method of manufacturing an absolute metal pressure measuring cell.

### Description of Related Art

Pressure transducers are used to measure pressure of fluids in various industrial applications. A common way to measure the pressure of a fluid or measurement medium, respectively, is to use a pressure measuring cell comprising a deflectable membrane, where a surface of the membrane is facing a volume of the measurement medium. Depending on the difference of the pressures at the surface facing the volume containing the measurement medium and at the surface facing away from the volume with the measurement medium, the membrane experiences a deflection which may be detected in order to determine the pressure of the measurement medium.

Depending on the reference with respect to which the pressure of the measurement medium is measured, different kinds of pressure measuring cells are discerned. In an absolute pressure measuring cell, for example, the pressure of the measurement medium is determined with respect to vacuum or another fixed reference pressure. In a relative pressure measuring cell, on the other hand, the pressure of the measurement medium is determined with respect to the current environment, such as for example atmospheric pressure.

A pressure transducer with a metal pressure measuring cell is for example described in EP 3 128 305 B1. There, a hermetic pressure sensor for measuring a fluid pressure is described, which comprises a first housing structure comprising a metal membrane section to be exposed to the fluid pressure; a second housing structure comprising a housing part with at least two openings and electrical connection pins passing through the at least two openings; at least one strain sensing element and a PCB electrically coupled to the electrical connection pins. The at least one strain sensing element is attached to the membrane section and electrically coupled to the PCB by bonding wires to mechanically decouple the membrane section for force acting on the PCB, the housing part of the second housing structure is a metal housing part configured to form a cover over the first housing part, the electrical connection pins are affixed in the at least two openings by a non-conductive and hermetic sealing material, springy electrical connection elements or a flex foil couple electrically the connection pins to the PCB, the first housing structure and the second housing structure are hermetically connected to each other to form a hermetically closed cavity in which the PCB and the at least one strain sensing element are located, and the first housing structure comprises a fluid facing outer surface to be exposed to the fluid pressure wherein the fluid facing outer surface is a full metal outer surface. The hermetic housing provides a constant internal pressure with respect to which the pressure of the fluid can be measured.

### SUMMARY OF THE INVENTION

For absolute pressure measuring cells made of metal, it is desired to provide a fixed reference pressure in a simple and reliable manner.

It is therefore an object of the invention to provide a metal pressure measuring cell for absolute pressure sensing, a pressure transducer comprising a metal pressure measuring cell for absolute pressure sensing and a method of manufacturing a metal pressure measuring cell for absolute pressure sensing.

According to the present invention, the object is achieved by the features and advantageous embodiments disclosed herein.

According to an aspect of the invention, the object is particularly achieved by a metal pressure measuring cell for absolute pressure sensing, comprising a metal base body with a membrane and a support body, the membrane comprising a first surface and a second surface, the support body comprising a cavity which is transversely delimited by an inner surface of the support body and axially delimited at a first side by the first surface of the membrane and open at a second side opposite to the first side to form a trough-shaped chamber for accommodating a measurement the medium, pressure measuring further cell comprising a cap mounted on the base body and covering the second surface of the membrane such that a hermetically closed pressure reference volume is formed between the cap and the second surface of the membrane, wherein the cap is made of metal.

By mounting a cap on the base body, covering the second surface of the membrane, a hermetically closed volume for a fixed reference pressure can be provided in a simple manner. In particular, a complex arrangement of a housing surrounding the whole pressure measuring cell can be avoided. Further, as the cap is also made of metal, interfaces of different materials, such as for example glass-metal or ceramics-metal interfaces, which are prone to mechanical stress and failure, can be avoided.

Preferably, the cap has an inner transverse area which is equal to or larger than the area of the membrane.

In this way, it can be ensured that the complete second surface of the membrane is covered by the pressure reference volume such that reliable absolute pressure sensing can be enabled. Furthermore, it can be ensured that a joint by which the cap is mounted on the base body is not arranged on top of the membrane, such that the membrane can be protected from mechanical load due to the joint. However, the joint is preferably arranged next to the radial boundary of the membrane such that the region of the joint can be kept simple and small. This allows to reduce the probability of leakage compared to, e.g., large and complex joints which seal a complete housing surrounding the entire pressure measuring cell.

Preferably, the coefficients of expansion of the base body and the cap are essentially equal.

By choosing materials with essentially equal coefficients of expansion for the base body and the cap, mechanical stress due to temperature changes, can be reduced.

Preferably, the base body and/or the cap are made of a duplex stainless, a ferritic or an austenitic steel.

Preferably, both the base body and the cap are made of a duplex stainless, a ferritic or an austenitic steel. Besides the equal coefficients of expansion, using a duplex stainless, a ferritic or austenitic steel for both the cap and the base body has the advantage that equal thermal conductivities can be provided which increases thermal shock resistance. Furthermore, a steel cap has the advantage that the cap can hermetically be soldered on the base body with a known surface-mount technology for SMDs (surface mounted devices).

In some embodiments, the cap has a circular cross-section.

Alternatively, the cap may have a rectangular or other polygonal cross-section.

In some embodiments, the cap comprises a transverse cover portion, a side wall and a flange transversely adjoining the side wall, wherein the cap is mounted on the base body by the flange.

Such a shape of the cap has the advantage that it can readily be manufactured by punching and stamping of a sheet metal. The flange provides a mounting portion which can be used for soldering the cap on the base body in a reliable manner.

The height of the side wall can be adjusted to obtain a pressure reference volume of a desired size. For example, the volume of the pressure reference volume may be, in some embodiments, larger than 40 mm³. In particular, the cap allows to obtain a pressure reference volume of a sufficiently large size while keeping the membrane and therefore the lateral extent of the pressure measuring cell sufficiently small. Further, with a defined size of the joint with a certain expected leakage rate, the pressure increase in the interior of the pressure reference volume is typically smaller for larger size of the pressure reference volume. Therefore, the cap advantageously allows to keep the pressure in the interior of the pressure reference volume small.

In some embodiments, the cap is mounted on the base body by soldering, preferably soft soldering.

The joints achieved by soldering have the advantage that an improved thermal shock resistance be can provided. Advantageously, a ductile soft solder joint is achieved which has an improved thermal shock resistance with respect to, e.g., glass soldered joints. Furthermore, soldering the cap on the base body has the advantage that the cycle time for joining can be reduced to a few minutes. Soldering has the further advantage that process temperatures can be reduced.

In some embodiments, the cap is mounted on the base body by vacuum soldering. This has the advantage that pressures of a few mbar, preferably smaller than 1 mbar, can be achieved within the pressure reference volume.

In some embodiments, a solderable metallic layer is arranged between the base body and the cap, the solderable metallic layer surrounding the second surface of the membrane.

The person skilled in the art understands that if the cap is “mounted on the base body” or “soldered on the base body” additional elements or layers such as for example the solderable metallic layer and/or additional insulating layers can be arranged between the cap and the base body which may contribute to forming the joint between the cap and the base body.

A soft solder may be deposited onto the metallic layer in a vacuum soldering system.

The metallic layer may have an annular shape, in particular for a cap with a circular cross-section.

In some embodiments, the solderable metallic layer is made of AgPd.

Alternatively, the solderable metallic layer may be made of Ag, AgPdPt or AgPt. Thick film materials such as AgPd, Ag, AgPdPt or AgPt have the advantage of good solderability and processability by lead-free low temperature reflow soldering.

Alternatively, the cap may be mounted on the base body using a metallic layer made of for example Ti/Pd/Au, Ta/Ta₂N/NiCr/Pd/Au, Ti/Pd/Cu/Ni/Au, etc. if thin film technology is used in manufacturing of the pressure measuring cell.

In some embodiments, an intermediate insulating layer is arranged between the base body and the metallic layer, the intermediate insulating layer surrounding the second surface of the membrane. The intermediate insulating layer is an electrically insulating layer.

The metallic layer and/or the intermediate insulating layer are arranged to laterally surround the second surface of the membrane such that the sensitivity of the membrane is not negatively affected. Preferably, the metallic layer and/or the intermediate insulating layer comprise an opening which is flush with the second surface of the membrane.

In some embodiments, a base insulating layer is arranged on the base body, covering also the second surface of the membrane. The base insulating layer is an electrically insulating layer. as Pressure measuring components such circuit elements, conductive tracks, sensor resistors etc. may then be applied onto the base insulating layer. The intermediate insulating layer is preferably deposited onto the base insulating layer carrying the pressure measuring components.

Typically, the pressure measuring cell may therefore have the following structure: base body, base insulating layer and pressure measuring components, intermediate insulating layer, solderable metallic layer, cap.

In some embodiments, the pressure in the pressure reference volume is below 20 mbar, preferably below 10 mbar, particularly preferably below 1 mbar.

In some embodiments, the inner surface of the support body is shaped such that a transverse diameter of the trough-shaped chamber monotonously decreases from the second side of the cavity towards the first side of the cavity.

Due to the monotonously decreasing transverse diameter of the trough-shaped chamber between the second side of the cavity and the first side of the cavity, a wall which is vertical along substantially the entire axial length of the cavity can be avoided. In particular, the different transverse diameters allow to introduce to the inner surface of the support body one or more slopes deviating from the vertical axis of the pressure measuring cell. By introducing one or more slopes to the inner surface of the support body, obstacles for the measurement medium can be obtained such that the area across which the freezing part of the measurement medium such as ice can freely and directly propagate towards the first surface of the membrane is reduced. This has the advantage that at least part of the forces arising from freezing of the measurement medium due to a density anomaly can be guided away from the membrane. By guiding said forces away from the membrane, mechanical stress on the membrane can be reduced which improves the drift characteristics of a pressure transducer comprising a pressure measuring cell according to the present disclosure.

Therefore, an effective “geometric” frost protection for the membrane can be obtained by shaping the trough-shaped chamber serving as a measurement volume in a refined manner according to the present disclosure. In particular, additional fault-prone compensation components such movable as and/or compressible/stretchable elements in the measurement volume may advantageously be reduced or avoided.

In the context of the present invention, “axial” shall typically be understood as a direction perpendicular to the membrane. Preferably, the axial direction of the pressure measuring cell represents an axis of symmetry of the trough-shaped chamber. The transverse direction or plane shall therefore be understood as a direction or plane perpendicular to the axial direction. The transverse diameters of the trough-shaped chamber at different axial heights of the pressure measuring cell shall be understood as the transverse diameters of the pressure measuring cell in a common vertical plane of the pressure measuring cell.

Due to the monotonously decreasing transverse diameter, a trough-shaped chamber with a gradually widening cross-section can be obtained. Further, a gradually widening inner profile of the trough-shaped chamber may have the advantage that the membrane area can be kept small.

In some embodiments, the inner surface of the support body may be shaped such that the transverse diameter of the trough-shaped chamber decreases strictly monotonously from the second side of the cavity towards the first side of the cavity. This allows to further increase the portions of the inner surface of the support body provided to guide forces arising from freezing away from the membrane.

In some embodiments, the inner surface of the support body may comprise a section with a transverse diameter of the trough-shaped chamber strictly monotonously decreasing towards the first side of the cavity, wherein the section extends over at least a quarter, a third or half of the axial height of the trough-shaped chamber.

In some embodiments, the ratio of the transverse diameter of the membrane to the axial height of the trough-shaped chamber is smaller than 3:1. In some embodiments, the ratio of the transverse diameter of the membrane to the axial height of the trough-shaped chamber is 1:1.

In some embodiments, the inner surface of the support body adjoins the first surface of the membrane with a slope.

Providing the inner surface of the support body or the cavity, respectively, with a slope adjacent to the membrane and with respect thereto allows to optimize the frost protection as the forces arising from freezing may be guided away from the membrane in its close vicinity. The slope may be formed by a linearly slanted section or by a curved section of the inner surface of the support body.

In some embodiments, the inner surface of the support body comprises one or more linearly slanted sections.

One or more linearly slanted sections may be introduced depending on the desired amount or fraction of forces to be guided away from the axial direction or the direction towards the membrane, respectively. Especially, different linearly slanted sections adjacent to another may exhibit different slopes. The one or more linearly slanted sections may furthermore be introduced with an optimized slope with respect to the membrane in order to adjust the direction to which the forces are guided when the measurement medium freezes at the respective site. Additionally, the one or more linearly slanted sections may be introduced taking into account specific freezing parameters, such as the direction of freezing of the measurement medium, which may depend on the structure and/or spatial mounting of the pressure measuring cell. The one or more slanted sections may for example take into account whether freezing of the measurement medium tends to begin from a region at the second side of the cavity or from a region at the first side of the cavity.

As increased widening of the trough-shaped chamber typically yields a decreased wall strength of the support body, the slope of the linearly slanted sections can be adjusted to provide an optimal frost protection by guiding away of the forces from the membrane and widening of the measurement volume and at the same time to provide a sufficiently large wall strength of the support body.

The linearly slanted sections may extend at least partially over the inner surface of the support body along the transverse peripheral direction. In some embodiments, the linearly slanted sections may be or may be part of a surface curved along the transverse peripheral direction of the cavity. For example, a linearly slanted section may be part of a cone. Alternatively or additionally, the linearly slanted section may be or may be part of a planar surface. The person skilled in the art therefore understands that the linearly slanted sections may be represented by a linearly slanted profile when taking a vertical cross-section through cavity or trough-shaped chamber, the respectively.

The inner surface of the support body may be shaped to form a trough-shaped chamber with n-fold rotational symmetry with respect to the axial direction of the pressure measuring cell.

In some embodiments, the trough-shaped chamber may exhibit a shape of a prismatoid extending over at least part of the axial height of the cavity. In some embodiments, the trough-shaped chamber may exhibit a shape of a frustum extending over at least part of the axial height of the cavity.

In some embodiments, the inner surface of the support body may be shaped to form a trough-shaped chamber with circular symmetry with respect to the axial direction of the pressure measuring cell. The trough-shaped chamber may for example exhibit a shape of a cone extending over at least part of the axial height of the cavity.

In some embodiments, the inner surface of the support body comprises at least two linearly slanted sections, wherein a linearly slanted section at the second side of the cavity exhibits a smaller slope with respect to the membrane than a linearly slanted section at the first side of the cavity.

Alternatively, the inner surface of the support body may comprise at least two linearly slanted sections, wherein a linearly slanted section at the second side of the cavity exhibits a larger slope than a linearly slanted section at the first side of the cavity.

The at least two linearly slanted sections may be formed by planar surfaces and/or surfaces curved along the transverse peripheral direction of the cavity.

In some embodiments, the inner surface of the support body comprises one or more conical profile sections.

The one or more conical profile sections may be arranged successively one after another. In particular, the one or more conical profile sections may extend over the circumference of the trough-shaped chamber, such that a rotationally symmetric profile may be obtained.

In some embodiments, a conical profile section, preferably arranged adjacent to the membrane, corresponds at least partially to a cone with an apex angle between 15° and 50°, preferably between 20° and 45°, particularly preferably between 22° and 43°.

By increasing the apex angle, guiding the forces away from the membrane when the measurement medium is freezing can be improved. Further, widening of the trough-shaped chamber can be increased. As increased widening of the trough-shaped chamber typically yields a decreased wall strength of the support body, the apex angle can be adjusted to provide an optimal frost protection by guiding away of the forces from the membrane and at the same time to provide a sufficiently large wall strength of the support body.

In particular, the one or more conical profile sections may correspond to a frustoconical shape due to the adjacent membrane or other adjacent conical, cylindrical, convex or concave profile sections.

In some embodiments, the inner surface of the support body comprises a conical profile section adjacent to the membrane and profile a cylindrical profile section adjoining the conical section.

The conical profile section and the cylindrical profile section may extend over the circumference of the trough-shaped chamber. The cylindrical profile section may adjoin the conical profile section by forming a step, such that a transverse annular surface area may be formed. The conical profile section adjacent to the membrane may therefore exhibit a smaller transverse cross-sectional area than the cylindrical profile section at the point where the conical profile section adjoins the cylindrical profile section. The transverse annular surface area may take up part of the force arising from freezing of the measurement medium and serve to protect the membrane from stress due to freezing of the measurement medium.

In some embodiments, the inner surface of the support body comprises a further conical profile section arranged between the cylindrical profile section and the second side of the cavity.

In some embodiments, the inner surface of the support body comprises a cylindrical profile section adjacent to the membrane and a conical profile section adjoining the cylindrical profile section. In particular, the conical profile section may correspond to a frustoconical shape due to the adjacent cylindrical profile section.

In some embodiments, the inner surface of the support body comprises at least two conical profile sections, wherein a cone corresponding to a conical profile section at the second end of a the cavity exhibits smaller apex angle than a cone corresponding to a conical profile section at the first end of the cavity.

Alternatively, the inner surface of the support body may comprise at least two conical profile sections, wherein a cone corresponding to a conical profile section at the second end of the cavity exhibits a larger apex angle than a cone corresponding to a conical profile section at the first end of the cavity.

In some embodiments, the inner surface of the support body comprises a conical profile extending from the second side of the cavity to the first side of the cavity.

Providing a conical profile extending from the second side of the cavity to the first side of the cavity has the advantage of an efficient frost protection together with a simple manufacturability of the pressure measuring cell.

In particular, the conical profile may correspond at least partially to a cone with an apex angle between 15° and 50°, preferably between 20° and 45°, particularly preferably between 22° and 43°.

In some embodiments, the inner surface of the support body comprises one or more concave, preferably concave parabolic, sections.

In the context of the present invention, a cylindrical profile section shall not be understood as a concave profile section. A concave profile section shall therefore usually be understood as comprising a substantial concave curved portion with respect to the (vertical) axis of the pressure measuring cell. Preferably, the concave profile section may therefore be a curved concave profile section with respect to the (vertical) axis of the pressure measuring cell.

In some embodiments, the inner surface of the support body comprises one or convex, more preferably convex parabolic, sections.

A convex profile section shall therefore usually be understood as comprising a substantial convex curved portion with respect to the (vertical) axis of the pressure measuring cell. Preferably, the convex profile section may be a curved convex profile section with respect to the (vertical) axis of the pressure measuring cell. By providing one or more concave and/or convex, preferably concave and/or convex parabolic, profile sections, a smooth widening of the inner profile of the trough-shaped chamber can be obtained. The concave and/or convex profile sections may extend over the circumference of the trough-shaped chamber. Depending on where the forces arising from freezing of the measurement medium shall mainly be guided away from the membrane, a concave or convex profile section may be provided. For example, a concave profile section may be provided at the first side of the cavity if efficient guiding away of the forces from the membrane shall be provided in this region of the cavity. A convex profile section may for example be provided at the second side of the cavity if efficient guiding away of the forces from the membrane shall be provided in the region of the second side of the cavity.

In some embodiments, the inner surface of the support body comprises a parabolic profile extending from the second side of the cavity to the first side of the cavity.

The parabolic profile may be concave or convex. In particular, the parabolic profile may extend over the circumference of the trough-shaped chamber. For a concave parabolic profile, the parabolic profile may correspond to a frustum paraboloid due to the membrane arranged at the first side of the cavity.

In some embodiments, the parabolic profile exhibits a larger curvature at the second side of the cavity than at the first side of the cavity.

Alternatively, the parabolic profile may exhibit a smaller curvature at the second side of the cavity than at the first side of the cavity.

The size of the curvatures of the parabolic profiles at the second side and the first side of the cavity may be adjusted with respect to each other depending on the desired geometry of the trough-shaped chamber or pressure measuring cell, respectively. For example, by choosing a convex parabolic profile with a larger curvature at the second side than at the first side of the cavity, a deeper trough-shaped chamber can be obtained. By choosing a convex parabolic profile with a smaller curvature at the second side than at the first side of the cavity, a shallower trough-shaped chamber can be obtained. Here, the vertical curvatures shall be considered when the curvatures are compared.

In some embodiments, the inner surface of the support body comprises at least two concave or convex profile sections, wherein adjacent concave or convex profile sections adjoin to one another forming a step-like profile.

In some embodiments, the inner surface of the support body comprises at least a concave profile section and at least a convex profile section adjoining to one another forming a step-like profile.

Concave and/or convex profile sections may adjoin to one another by forming a step, such that an annular surface area may be formed. The annular surface area may take up part of the force arising from freezing of the measurement medium.

In some embodiments, the inner surface of the support body comprises a concave or convex section adjacent to a conical profile section.

In some embodiments, the inner surface of the support body adjoins the first surface of the membrane perpendicularly.

In particular, the inner surface of the support body may comprise a cylindrical profile section adjoining the first surface of the membrane and a conical or concave or convex profile section adjoining the cylindrical profile section by forming a step.

In some embodiments where the inner surface of the support body comprises a cylindrical profile section and a conical or concave or convex profile section adjoining the cylindrical profile section, the conical or concave or convex profile section may extend over at least one third of the axial height of the trough-shaped chamber and the cylindrical profile section may extend over at most two thirds of the axial height of the trough-shaped chamber. Other partitions between the cylindrical profile section and the conical or concave or convex profile section with respect to the axial height of the trough-shaped chamber may also be possible, for example half/half, at least two thirds/at most one third, at least one quarter/at most three quarters, at least three quarters/at most one quarter etc.

In some embodiments where the inner surface of the support body comprises a conical profile section and an adjoining concave or convex profile section, similar partitions between the conical profile section and the concave or convex profile section may be possible, for example half/half, at least two thirds/at most one third, at least one quarter/at most three quarters, at least three quarters/at most one quarter, etc.

In some embodiments where the inner surface of the support body comprises a concave and a convex profile section or two concave or convex profile sections, similar partitions between the concave and convex profile sections or between the two concave or convex profile sections may be possible, for example half/half, at least two thirds/at most one third, at least one quarter/at most three quarters, at least three quarters/at most one quarter etc.

In some embodiments where the inner surface of the support body comprises two conical profile sections, similar partitions between the two conical profile sections may be possible, for example half/half, at least two thirds/at most one third, at least one quarter/at most three quarters, at least three quarters/at most one quarter, etc.

In some embodiments, the pressure measuring cell comprises a coating on the inner surface of the support body. The coating may comprise one or more of: a polymer, for example a parylene, silicon, diamond-like carbon or hydrocarbon, TiAIN, TiCN, TiSi.

The coating can advantageously be used to reduce the roughness of the inner surface of the support body, such that the friction between the trough-shaped chamber and the measurement medium can be reduced.

In some embodiments, the inner surface of the support body exhibits a roughness Ra<3.0 μm, preferably Ra<2.0 μm, particularly preferably Ra<1.8 μm.

Reducing the roughness of the inner surface of the support body may be achieved by a coating on the inner surface or by a separate surface treatment of the inner surface of the support body, such as for example lapping, polishing, sandblasting, precision turning, etc. Reducing the roughness of the inner surface of the support body has the advantage that freezing of the measurement medium can be delayed.

In some embodiments, the pressure measuring cell comprises a liner insert for the trough-shaped chamber, wherein the liner insert is arranged to cover at least part of the inner surface of the support body transversely delimiting the cavity.

Preferably, the liner insert covers the inner surface of the support body transversely delimiting the cavity. Preferably, the liner insert covers the side wall or side walls of the trough-shaped chamber but leaves the membrane open. In some embodiments, however, the liner insert may also cover the first surface of the membrane. The liner insert can advantageously be used to reduce the roughness of the inner surface of the support body, such that the friction between the trough-shaped chamber and the measurement medium can be reduced. The liner insert may be made of a compressible material. As the liner insert has a thickness which is larger than the thickness of a coating, a certain flexibility and/or compressibility can therefore be provided such that the liner insert may take up part of the forces arising from freezing of the measurement medium.

The liner insert may comprise a shape which corresponds to the profile of the inner surface of the support body. The liner insert may therefore exhibit one or conical profile sections, a cylindrical profile section, one or more concave and/or convex profile sections.

In some embodiments, the liner insert comprises outer ribs on an outer surface facing the inner surface of the support body for mounting the liner insert at the trough-shaped chamber. Accordingly, the inner surface of the support body may comprise recesses corresponding to the outer ribs of the liner insert, wherein the outer ribs may be configured to engage into the recesses, such that the liner insert may be securely mounted at the trough-shaped chamber.

In some embodiments, the liner insert comprises outer ribs on an outer surface facing the inner surface of the support body for generating one or more buffer chambers between the inner surface of the support body and the liner insert. In such embodiments, the inner surface of the support may therefore not comprise recesses in which the outer ribs engage into. Instead, the outer ribs may abut on the even inner surface of the support body and serve as spacer elements. The buffer chambers may advantageously serve as compressible chambers to take up a volume change of the freezing measurement medium. In order to prevent the buffer chambers from compressing or collapsing before the measurement medium freezes, the liner insert is preferably made of a sufficiently rigid plastic.

The liner insert may further comprise a flange configured to abut on an outer transverse surface of the support body adjacent to the second side of the cavity.

In some embodiments, the liner insert is made of a urea-resistant elastomer, for example ethylene propylene diene monomer rubber or nitrile butadiene rubber.

According to a further aspect, the present invention is also directed to a method of manufacturing the pressure measuring cell according to one of the preceding claims, comprising the steps of: providing a base body made of a metal, preferably a duplex stainless, a ferritic or an austenitic steel, with a membrane and a support body; arranging an intermediate insulating layer on the base body to surround the membrane; forming a solderable metallic layer on the intermediate insulating layer to surround the membrane; mounting a cap made of a metal on the base body by soldering a mounting portion of the cap, preferably a flange, onto the metallic layer.

As described above, a base insulating layer may be formed on the base body, covering the second surface of the membrane. Pressure measuring components may be applied on the insulating layer. Arranging the intermediate insulating layer on the base body may therefore typically comprise applying the intermediate insulating layer onto the base insulating layer.

In some embodiments, the cap is manufactured by punching and stamping of a sheet metal.

In some embodiments, the mounting portion of the cap is soldered onto the metallic layer by vacuum soldering.

In some embodiments, the cap is made of a duplex stainless steel, a ferritic steel or an austenitic steel.

According to a further aspect, the present invention is also directed to an absolute pressure transducer configured to measure pressure of a measurement medium with a density anomaly, comprising a pressure measuring cell according to the present disclosure.

Due to the frost protection achieved by the particular geometry of the trough-shaped chamber, the pressure measuring cell may particularly be advantageous for use in a pressure transducer configured to measure pressure of a measurement medium with a density anomaly. In particular, additional fault-prone compensation components such as movable and/or compressible/stretchable elements in the measurement volume may advantageously be reduced or avoided for the pressure transducer according to the present disclosure.

In some embodiments, the trough-shaped chamber is an empty space for accommodating solely the measurement medium.

As mentioned above, additional compensation components such as for example movable elements within the measurement volume can be avoided such that the trough-shaped chamber can fully be accommodated by the measurement medium.

In some embodiments of a pressure transducer with a conical or parabolic profile extending from the second side to the first side of the cavity, the pressure transducer may optionally comprise a pin arranged at least partially in the trough-shaped chamber. The pin may have a cylindrical or a conical shape. A pin of a conical shape has the advantage that a portion of the freezing measurement medium may become wedged with the pin and thereby be spatially fixed remote from the membrane. The pin may be static or movable and compressible or incompressible. A movable pin has the advantage that the size of the measurement volume may be adaptable during freezing of the measurement medium. A compressible pin has the advantage that the pin may take up part of the volume change when the measurement medium freezes. A pin may further be used to advantageously control the freezing characteristics e.g. by way of choosing a material with a specific thermal conductivity in order to adjust the regions where freezing of the measurement medium begins earlier compared to configurations without a pin. Although the “geometric” frost protection provided by the profile of the trough-shaped chamber has the advantage that additional compensation elements in the measurement volume may be reduced or avoided, the optional pin may therefore advantageously serve to additionally improve the frost protection. Likewise, the pressure transducer may, in some embodiments, comprise additional optional compensation elements, such as for example a bellows on which the pressure measuring cell is mounted by its second side of the cavity.

According to a further aspect, the present invention is also directed to a dosing unit for dosing an exhaust gas reduction medium, preferably diesel exhaust fluid, comprising a pressure transducer according to the present disclosure.

### BRIEF DESCRIPTION OF THE DRAWINGS

The terms Fig., Figs., Figure, and Figures are used interchangeably in the specification to refer to the corresponding figures in the drawings.

The present invention will be explained in more detail, by way of exemplary embodiments, with reference to the schematic drawings, in which:

FIG. 1 shows an illustration of an embodiment of a pressure measuring cell in a vertical cut view;

FIG. 2 shows an illustration of an embodiment of a pressure measuring cell in a perspective view before mounting of the cap;

FIG. 3 shows the pressure measuring cell of FIG. 2 after mounting of the cap;

FIG. 4 shows illustration of an embodiment of a pressure measuring cell in a vertical cut view with a cavity comprising two conical profile sections;

FIG. 5 shows an illustration of an embodiment of a pressure measuring cell in a vertical cut view with a cavity comprising a conical profile;

FIG. 6 shows an illustration of an embodiment of a pressure measuring cell in a vertical cut view with a cavity comprising two conical profile sections and a cylindrical profile section;

FIG. 7 shows an illustration of an embodiment of a pressure measuring cell in a vertical cut view with a cavity comprising a concave parabolic profile;

FIG. 8 shows an illustration of an embodiment of a pressure measuring cell in a vertical cut view with a cavity comprising a cylindrical profile section and a concave profile section;

FIG. 9 shows an illustration of an embodiment of a pressure measuring cell in a vertical cut view with a cavity comprising a convex parabolic profile;

FIG. 10 shows an illustration of an embodiment of a pressure measuring cell in a vertical cut view with a cavity comprising two convex profile sections;

FIG. 11 shows an illustration of an embodiment of a pressure measuring cell in a vertical cut view with a cavity comprising a convex profile section and a conical profile section;

FIG. 12a shows an illustration of an embodiment of a pressure transducer in a vertical cut view;

FIG. 12b shows an illustration of a further embodiment of a pressure transducer in a vertical cut view;

FIG. 13 shows an illustration of an embodiment of a dosing unit in a vertical cut view;

FIG. 14 shows an illustration of an embodiment of a pressure measuring cell in a vertical cut view where a pin is arranged in the trough-shaped chamber;

FIG. 15 shows an illustration of an embodiment of a pressure measuring cell in a vertical cut view with a liner insert;

FIG. 16 shows an illustration of an embodiment of a pressure measuring cell in a vertical cut view with a liner insert.

### DETAILED DESCRIPTION

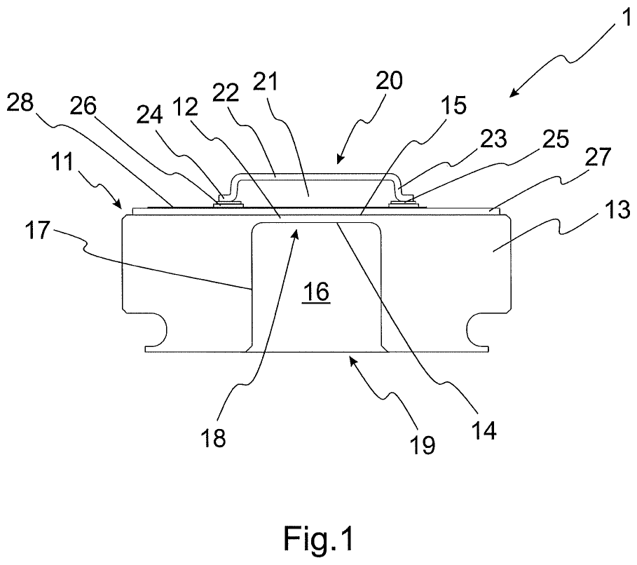

FIG. 1 shows an illustration of an embodiment of a metal pressure measuring cell 1 comprising a metal base body 11 with a membrane 12 and a support body 13. The membrane 12 comprises a first surface 14 and a second surface 15. The support body 13 comprises a cavity 16 which is transversely delimited by an inner surface 17 of the support body 13 and axially delimited at a first side 18 by the first surface 14 of the membrane 12 and open at a second side 19 opposite to the first side 18, such that a trough-shaped chamber 16 is formed. The trough-shaped chamber 16 accommodates a measurement medium, such as a diesel exhaust fluid. The first surface 14 is facing towards the measurement medium and the second surface 15 is facing away from the measurement medium. The inner surface 17 of the support body 13 forms a side wall surface of the cavity 16.

The pressure measuring cell 1 further comprises a cap 20 mounted on the base body 11 and covering the second surface 15 of the membrane 12. A hermetically closed pressure reference volume 21 is formed between the cap 20 and the second surface 15 of the membrane 12. The cap 20 comprises a transverse cover portion 22, a side wall 23 and a flange 24 transversely adjoining the side wall 23. The cap 20 is mounted on the base body 13 by the flange 24 by vacuum soft soldering. A base insulating layer 27 is arranged on the base body 11, covering also the second surface 15 of the membrane 12. The base insulating layer 27 extends over a major portion of the top surface of the base body 11. Pressure measuring components 28, as symbolized by a solid line, are applied onto the base insulating layer 27. An intermediate insulating layer 26 is mounted on the base insulating layer 27 carrying the pressure measuring components 28 so as to be arranged between the base body 13 and a solderable metallic layer 25 made of AgPd. The solderable metallic layer 25 mounted on the intermediate insulating layer 26 is arranged between the base body 11 and the cap 20, wherein the cap 20 is soldered onto the solderable metallic layer 25. The insulating layer 26 and the metallic layer 25 have an annular shape with a central opening which is flush with the second surface 15 of the membrane 12. The cap 20 and the base body 11 are made of a duplex stainless, ferritic or an austenitic steel. The transverse area of the pressure reference volume 21 is larger than the area of the second surface 15 of the membrane 12. The pressure in the pressure reference volume 21 is smaller than 1 mbar. The cap 20 and the transverse cover portion 22 have a circular shape. The cavity 16 has a cylindrical profile. However, other profiles of the cavity 16 are possible, as shown in the present disclosure. The cap 20 is manufactured from a sheet metal by punching and stamping.

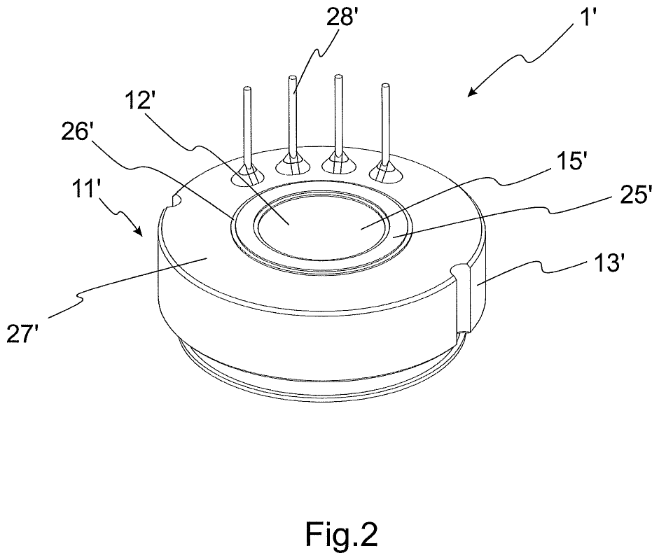

FIG. 2 shows an illustration of an embodiment of a metal pressure measuring cell 1′ in a perspective view before mounting of the cap. The metal base body 11′ comprising the membrane 12′ and the support body 13′ exhibits a circularly symmetric shape (except for e.g. electrical structures such as connection pins or small deviating structures of the base body such as recesses etc.). An intermediate insulating layer 26′ is arranged on the base body 11′. In particular, the intermediate insulating layer 26′ is mounted on a base insulating layer 27′ carrying pressure measuring components. The intermediate insulating layer 26′ has an annular shape surrounding the second surface 15′ of the membrane 12′. On the intermediate insulating layer 26′, there is mounted a solderable metallic layer 25′, onto which the cap is to be soldered. The metallic layer 25′ has an annular shape surrounding the second surface 15′ of the membrane 12′. Four connection pins 28′ for electrically connecting to pressure measuring components are arranged on the base body 11′ of the pressure measuring cell 1′.

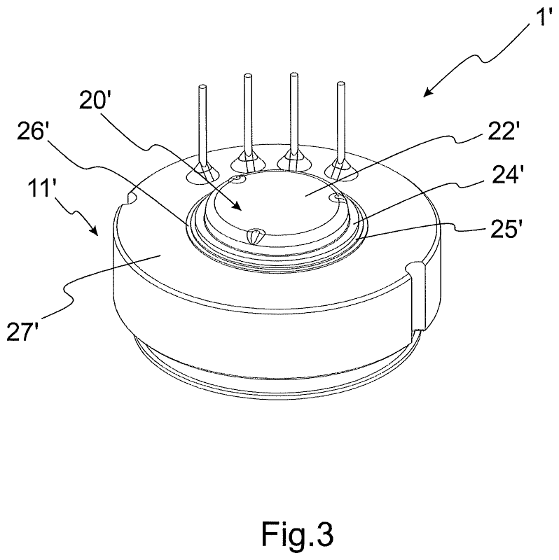

FIG. 3 shows the pressure measuring cell 1′ of FIG. 2 after mounting of the cap 20′. The cap 20′ is mounted on the base body 11′ by vacuum soft soldering of the flange 24′ onto the solderable metallic layer 25′ shown in FIG. 2. The metallic layer 25′ of FIG. 2 is therefore arranged between the base body 11′ and the cap 20′, in particular between the intermediate insulating layer 26′ and the flange 24′. The cap 20′ has a circular transverse cross section and comprises a circular transverse cover portion 22′.

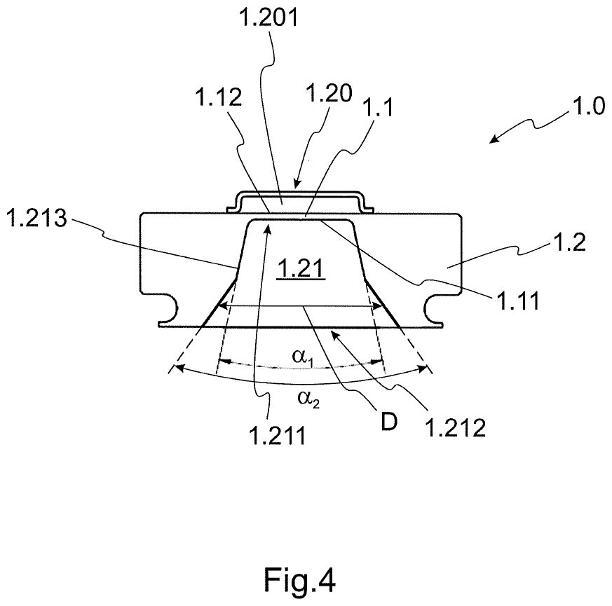

FIG. 4 shows an illustration of an embodiment of a metal pressure measuring cell 1.0 comprising a membrane 1.1 with a first surface 1.11 and a second surface 1.12. The pressure measuring cell 1.0 is made of a duplex stainless, a ferritic or an austenitic steel. The pressure measuring cell 1.0 further comprises a support body 1.2 with a cavity 1.21 which is transversely delimited by an inner surface 1.213 of the support body 1.2. The inner surface 1.213 of the support body 1.2 therefore forms a side wall surface of the cavity 1.21. The cavity 1.21 is axially delimited at a first side 1.211 by the first surface 1.11 of the membrane 1.1 and open at a second side 1.212 opposite to the first side 1.211. The cavity 1.21 therefore forms a trough-shaped chamber 1.21 which accommodates a measurement medium, such as a diesel exhaust fluid. The ratio of the transverse diameter of the membrane 1.1 to the axial height of the trough-shaped chamber 1.21 is about 1:1. The first surface 1.11 of the membrane 1.1 is facing towards the measurement medium and the second surface 1.12 of the membrane 1.1 is facing away from the measurement medium.

As can be recognized in FIG. 4, the transverse diameter D of the trough-shaped chamber 1.21 at the second side 1.212 of the cavity 1.21 is larger than the transverse diameter D of the trough-shaped chamber 1.21 at the first side 1.211 of the cavity 1.21. For the shown pressure measuring cell 1, the transverse diameter D strictly monotonously decreases from the second side 1.212 of the cavity 1.21 towards the first side 1.211 of the cavity 1.21. The transverse diameter D at different axial heights of the pressure measuring cell 1 is measured in a common vertical plane oriented perpendicular to the membrane 1.1. In the shown example, the common vertical plane coincides with the plane of drawing.

The inner surface 1.213 of the support body 1.2 or the cavity 1.21, respectively, comprises a first conical profile section adjacent to the membrane 1.1 and extending over about half of the axial length of the trough-shaped chamber 1.21. The first conical profile section corresponds to a cone (or a frustocone) with an apex angle di. The inner surface 1.213 of the support body 1.2 or the cavity 1.21, respectively, further comprises a second conical profile section adjoining the first conical profile section and extending towards the second side 1.212 of the cavity 1.21, corresponding to a cone with a larger apex angle α₂ than the cone of the first conical profile section. The first and second conical profile sections furthermore extend around the circumference of the trough-shaped chamber 1.21 which exhibits circular symmetry with respect to the axial direction of the pressure measuring cell 1. The axial direction of the pressure measuring cell 1 is perpendicular to the plane of the membrane 1.1.

Due to the first conical profile section, the inner surface 1.213 of the support body 1.2 adjoins the first surface 1.12 of the membrane 1.1 with a slope. Furthermore, the first and second conical profile sections represent linearly slanted sections of the inner surface 1.213 of the support body 1.2 exhibiting two different slopes with respect to the plane of the membrane 1.1, as the conical profile sections are only curved in transverse direction and linearly slanted in vertical direction. The person skilled in the art furthermore understands that small curvatures as e.g. recognizable at the transition from the first surface 1.11 of the membrane 1.1 to the first conical profile section, due to for example manufacturing imperfections are not to be understood as concave or convex profile sections. The linearly slanted section adjoining the first surface 1.11 of the membrane therefore to be understood disregarding such small 1.1 is curvatures. Similarly, small chamfers, e.g., at the first or second side of the cavity without substantial effect on frost protection shall not be understood as separate conical profile sections. The different apex angles mentioned above translate into the slope of the linearly slanted section at the second side 1.212 of the cavity 1.21 being smaller than the slope of the linearly slanted section adjacent to the membrane 1.1.

The pressure measuring cell 1.0 further comprises a cap 1.20 mounted onto the support body 1.2 and covering the second surface 1.12 of the membrane 1.1. A hermetically closed pressure reference volume 1.201 is formed between the cap 1.20 and the second surface 1.12 of the membrane 1.1. The cap 1.20 is made of a duplex stainless, a ferritic or an austenitic steel.

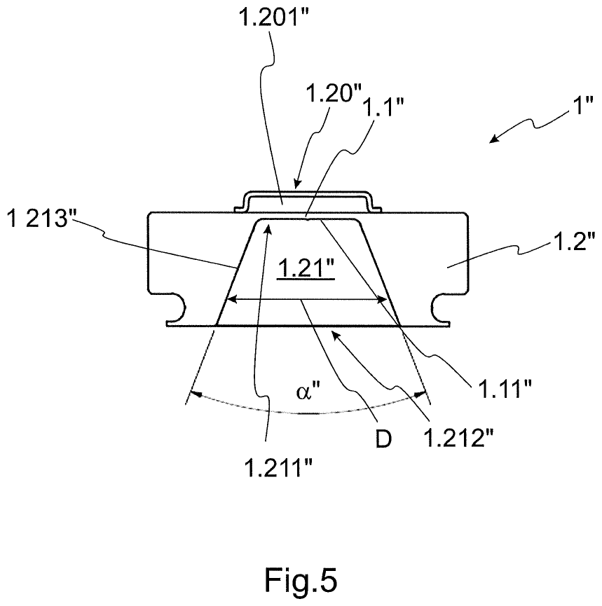

FIG. 5 shows a further embodiment of a metal pressure measuring cell 1″. The pressure measuring cell 1″ is similar to the pressure measuring cell 1 shown in FIG. 4, with the difference that the inner surface 1.213″ comprises a conical profile extending from the second side 1.212″ of the cavity 1.21″ to the first side 1.211″ of the cavity 1.21″ and that the apex angle α″ of the cone to which the conical profile corresponds is larger than the apex angle α of the cone of the first conical profile section shown in FIG. 4. Due to the larger apex angle, the trough-shaped chamber 1.21″ of the pressure measuring cell 1″ exhibits a more efficient guiding away of the forces from the membrane arising from freezing of the measurement medium and a larger measuring volume compared to the trough-shaped chamber 1.21 of the pressure measuring cell 1 shown in FIG. 4. The pressure measuring cell 1″ also comprises a cap 1.20″ and a pressure reference volume 1.201″.

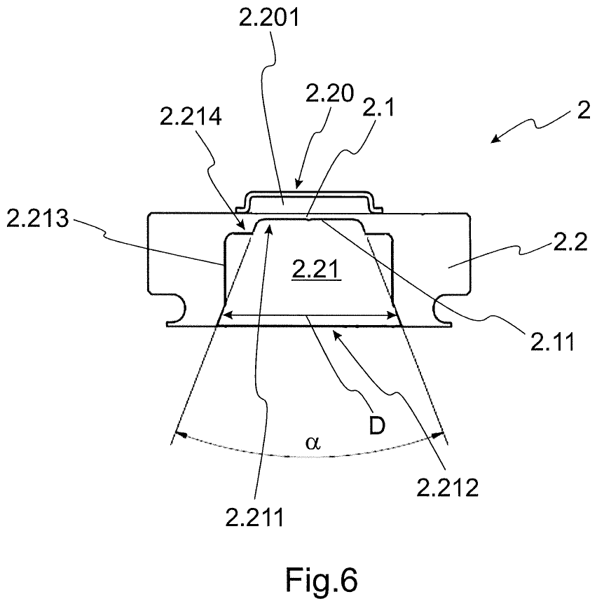

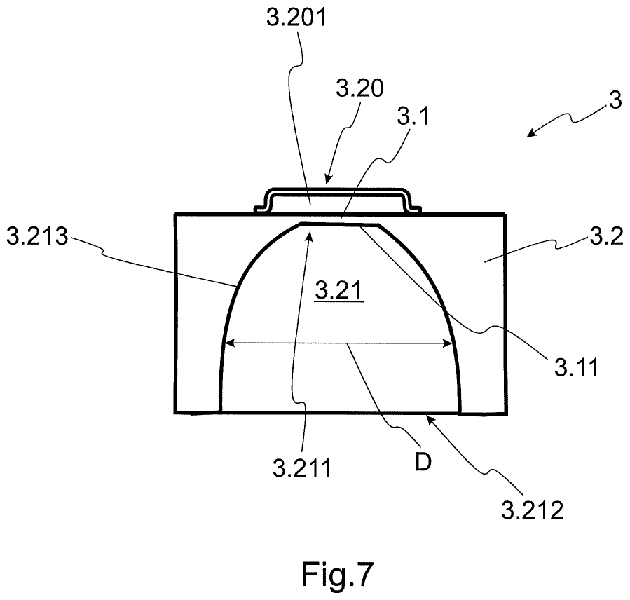

FIG. 6 shows a further embodiment of a metal pressure measuring cell 2 where the inner surface 2.213 of the cavity 2.21 or the support body 2.2, respectively, comprises a first conical profile section adjacent to the first surface 2.11 of the membrane 2.1 and a cylindrical profile section adjoining the first conical profile section. The pressure measuring cell 2 comprises a cap 2.20 and a pressure reference volume 2.201. The pressure measuring cell 2 is made of a duplex stainless, a ferritic or an austenitic steel. The cylindrical profile section and the first conical profile section adjoin to each other forming a step 2.214 such that a transverse annular surface area is formed. The inner surface 2.213 of the support body 2.2 comprises a second conical profile section arranged between the cylindrical profile section and the second side 2.212 of the cavity 2.21. The first and second conical profile sections correspond to a cone with the same apex angle α, which has the advantage of easier manufacturability. However, the apex angles may also differ from one another depending on the desired freezing characteristics. FIG. 7 shows a further embodiment of a metal pressure measuring cell 3 with a cap 3.20 and a pressure reference volume 3.201. The inner surface 3.213 of the support body 3.2 or the cavity 3.21, respectively, comprises a parabolic profile extending from the second side 3.212 of the cavity 3.21 to the first side of the cavity 3.21. Due to the parabolic profile, the inner surface 3.213 adjoins the first surface 3.11 of the membrane 3.1 with a slope. The parabolic profile represents a concave profile (section) of the inner surface 3.213 of the support body 3.2 extending around the circumference of the trough-shaped chamber 3.21 (or the cavity 3.21, respectively) and from the second side 3.212 to the first side 3.211 of the cavity 3.21. The parabolic profile exhibits a shape of a frustum paraboloid due to the membrane 3.1 transversely intersecting the parabolic profile. The curvature of the parabolic profile at the second side 3.212 of the cavity 3.21 is smaller than the curvature at the first side 3.211 of the cavity 3.21. In comparing the curvatures, the vertical curvatures shall be considered, as shown in FIG. 7. Guiding the forces arising from freezing away from the membrane therefore occurs predominantly in the vicinity of the membrane 3.1 in the region of the first side 3.211 of the cavity 3.21.

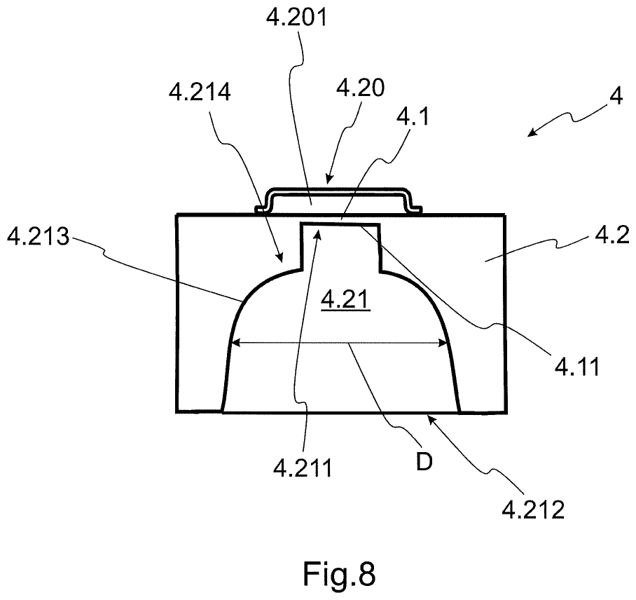

FIG. 8 shows a further embodiment of a metal pressure measuring cell 4 with a cap 4.20 and a pressure reference volume 4.201. The inner surface 4.213 of the support body 4.2 comprises a cylindrical profile section adjoining the first surface 4.11 of the membrane 4.1. The inner surface 4.213 of the support body 4.2 therefore adjoins the first surface 4.11 of the membrane 4.1 perpendicularly. The cylindrical profile section extends over the circumference of the trough-shaped chamber 4.21. A concave profile section adjoins the cylindrical profile section by forming a step 4.214. The concave profile section extends over the circumference of the trough-shaped chamber and from the cylindrical profile section to the second side 4.212 of the cavity 4.21. The concave profile section extends over about three quarters of the axial height of the trough-shaped chamber 4.21 wherein the cylindrical profile section extends over about one quarter of the axial height of the trough-shaped chamber 4.21. While a particular partition is shown in present FIG. 8, it is clear that other partitions between the cylindrical profile section and the concave profile section, as disclosed above, are also possible.

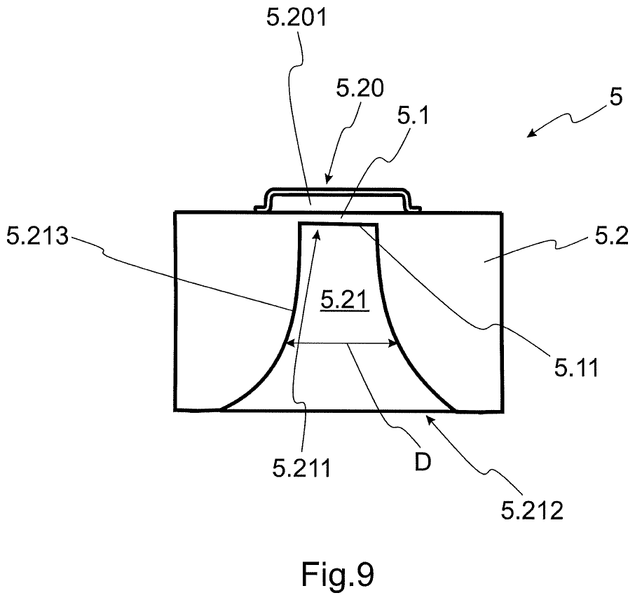

FIG. 9 shows a further embodiment of a metal pressure measuring cell 5 with a cap 5.20 and a pressure reference volume 5.201. The inner surface 5.213 of the support body 5.2 comprises a parabolic profile extending from the second side 5.212 to the first side 5.211 of the cavity 5.21 and over the circumference of the trough-shaped chamber 5.21 (or the cavity 5.21, respectively). Compared to the embodiment shown in FIG. 7, the parabolic profile is convex. The curvature of the parabolic profile at the second side 5.212 of the cavity 5.21 is larger than the curvature of the parabolic profile at the first side 5.211 of the cavity 5.21. Guiding the forces away from the membrane therefore occurs predominantly in the region of the second side 5.212 of the cavity 5.21. The inner surface 5.213 of the support body 5.2 adjoins the first surface 5.11 of the membrane 5.1 with a large slope or almost perpendicularly.

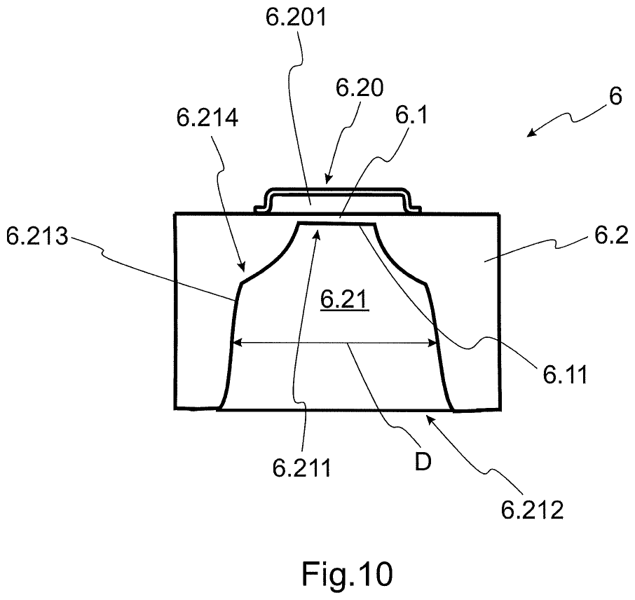

FIG. 10 shows a further embodiment of a metal pressure measuring cell 6 with a cap 6.20 and a pressure reference volume 6.201. The inner surface 6.213 of the support body 6.2 comprises two convex profile sections adjoining to one another. A first convex profile section adjoins the membrane 6.1 with a slope and extends over the circumference of the trough-shaped chamber 6.21. A second convex profile section adjoins the first convex profile section by forming a step 6.214 and extends from the from the first convex profile section to the second end 6.212 of the cavity 6.21. The second convex profile section also extends around the circumference of the trough-shaped chamber 6.21. The second convex profile section exhibits a smaller curvature than the first convex profile section. The inner surface 6.213 of the support body 6.2 is therefore steeper at the second convex profile section than at the first convex profile section. The second convex profile section in turn exhibits a larger curvature at the second side 6.212 of the cavity than at the step where the first and second convex profile sections adjoin to one another. The first convex profile section extends over about one third of the axial height of the trough-shaped chamber 6.21 and the second convex profile section extends over about two thirds of the axial height of the trough-shaped chamber 6.21. While a particular partition is shown in present FIG. 10, it is clear that other partitions between the two convex profile sections, as disclosed above, are also possible.

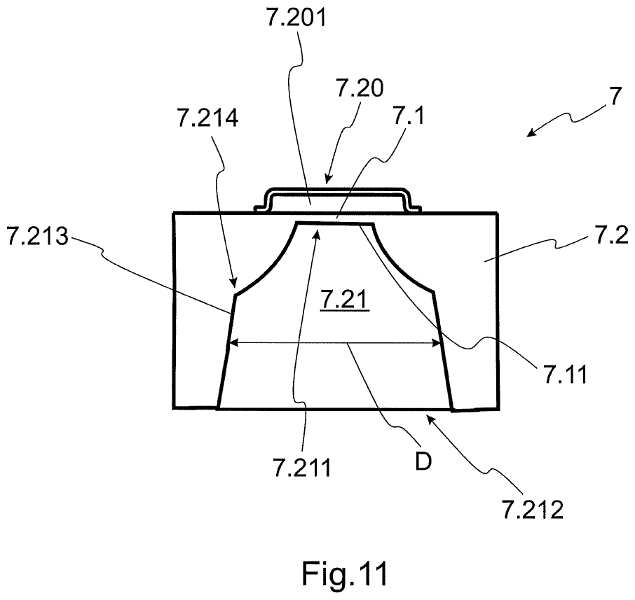

FIG. 11 shows a further embodiment of a metal pressure measuring cell 7 with a cap 6.20 and a pressure reference volume 6.201. The pressure measuring cell 7 is similar to the pressure measuring cell 6 shown in FIG. 10 with the difference that instead of the second convex profile section, a conical profile section adjoins the first convex profile section. The inner surface 7.213 of the support body 7.2 thus comprises a convex profile section adjoining the first surface 7.11 of the membrane 7.1 and a conical profile section adjoining the convex profile section by forming a step. The conical profile section extends from the convex profile section to the second side 7.212 of the cavity 7.21. Both the convex profile section and the conical profile section extend over the circumference of the trough-shaped chamber 7.21.

The pressure measuring cells as shown in FIGS. 4-16 may comprise a base insulating layer, an intermediate insulating layer and a solderable metal layer, as described for example in connection with FIG. 1, although not explicitly shown in the FIGS. 4-16.

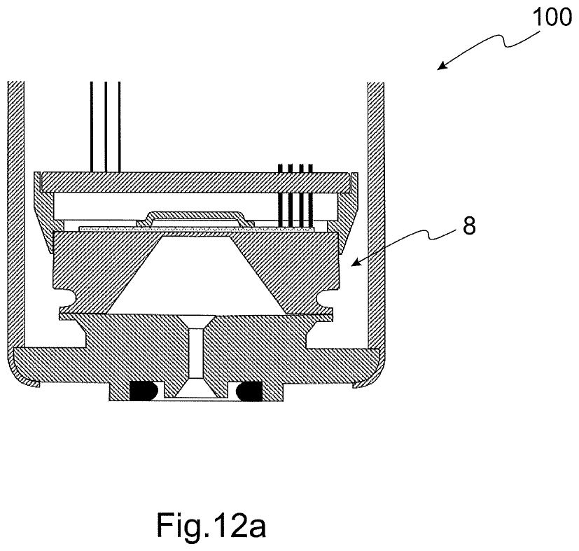

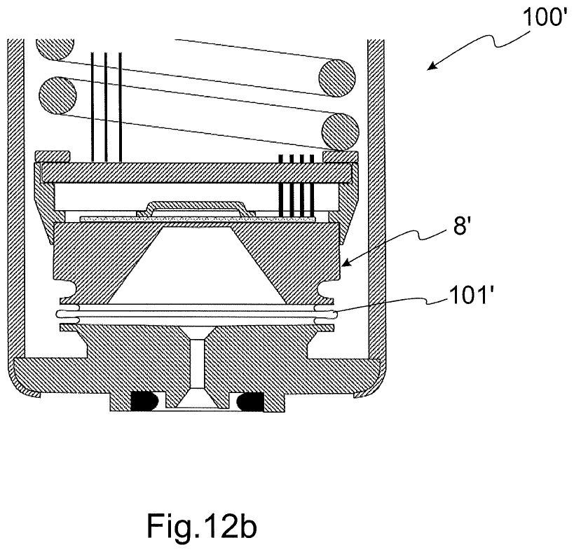

FIG. 12a shows an embodiment of a pressure transducer 100 comprising an embodiment of a pressure measuring cell 8. The pressure measuring cell 8 corresponds to the embodiment shown in FIG. 5 and comprises a trough-shaped chamber with a conical profile.

FIG. 12b shows an embodiment of a pressure transducer 100′ comprising an embodiment of a pressure measuring cell 8′. Again, the pressure measuring cell 8′ corresponds to the embodiment shown in FIG. 5 and comprises a trough-shaped chamber with a conical profile. Different to the embodiment of a pressure transducer shown in FIG. 12a, the pressure transducer 100′ comprises a bellow 101′ as a compensation element to further improve the frost protection by enabling a adaptable size of the measurement volume.

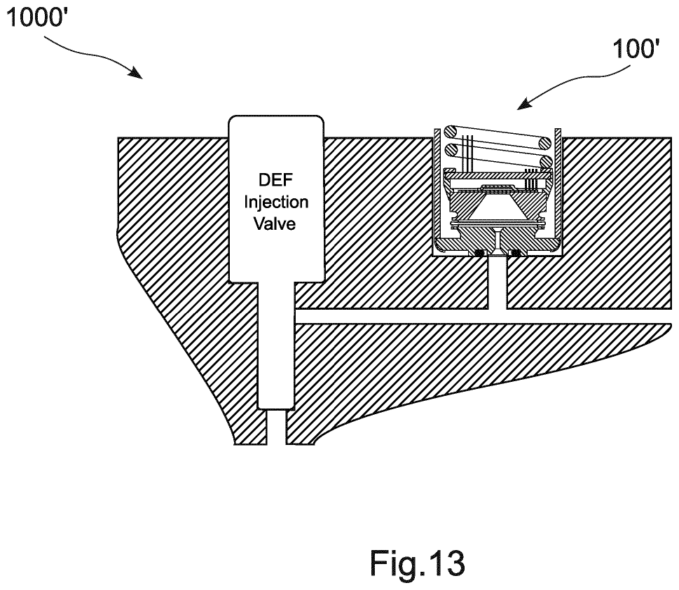

FIG. 13 shows an embodiment of a dosing unit 1000′ for dosing an exhaust gas reduction medium comprising the pressure transducer 100′ of FIG. 12b.

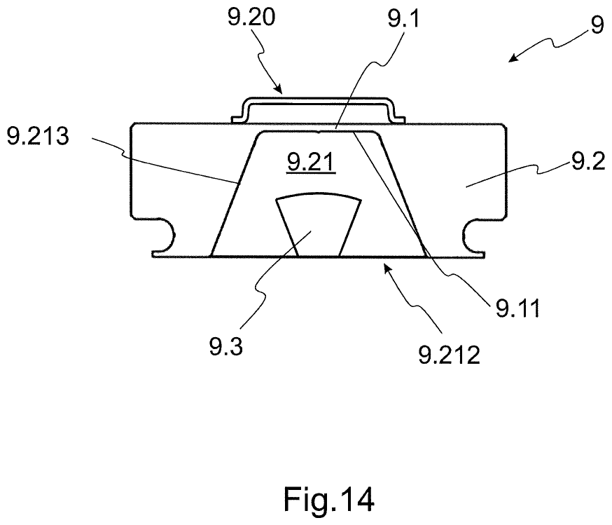

FIG. 14 shows a further embodiment of a pressure measuring cell 9 with a cap 9.20 where a pin 9.2 is at least partially arranged in the trough-shaped chamber 9.21. The pin 9.3 has a conical shape. A portion of ice of a measurement medium freezing from the second side 9.212 of the cavity 9.21 may become wedged between the pin 9.3 and the inner surface 9.213 of the support body 9.2 and thereby be spatially fixed at a site remote from the first surface 9.11 of the membrane 9.1.

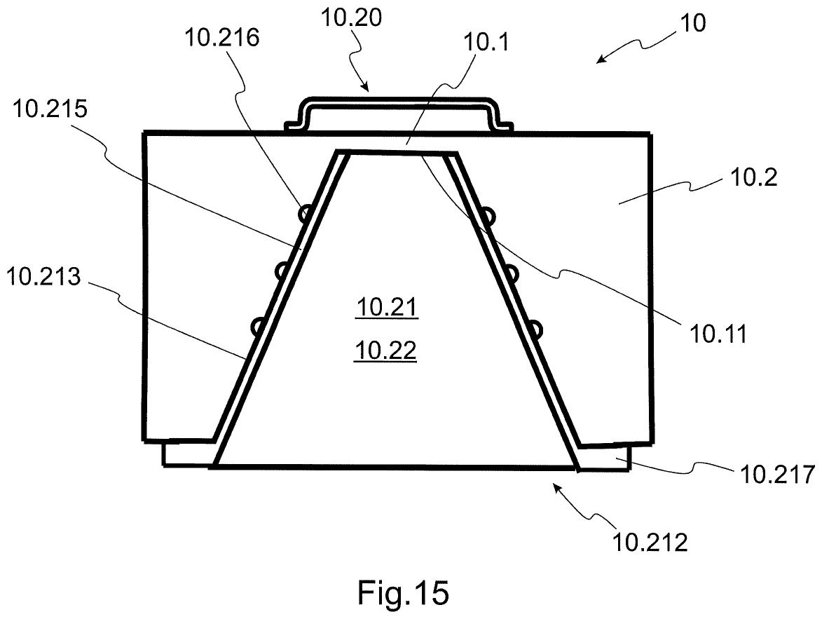

FIG. 15 shows a further embodiment of a pressure measuring cell 10 with a cap 10.20. The inner surface 10.213 of the support body profile. A liner insert 10.215 is 10.2 comprises a conical arranged in the cavity 10.21 to cover the inner surface 10.213 of the support body 10.2 forming the side wall of the cavity 10.21. The liner insert 10.215 comprises ribs 10.216 which engage with corresponding recesses in the inner surface 10.213 of the support body 10.2 for secure mounting of the liner insert 10.215. The liner insert 10.215 further comprises a flange 10.217 which abuts on an outer transverse surface of the support body 10.2 at the second side 10.212 of the cavity 10.21. The liner insert 10.215 has a conical shape and forms a side wall of the trough-shaped chamber 10.22. The liner insert 10.215 is open at the upper end in order to leave the first surface 10.11 of the membrane 10.1 open. The liner insert 10.215 is made of a urea-resistant elastomer and has a lower roughness than the inner surface 10.213 of the support body 10.2.

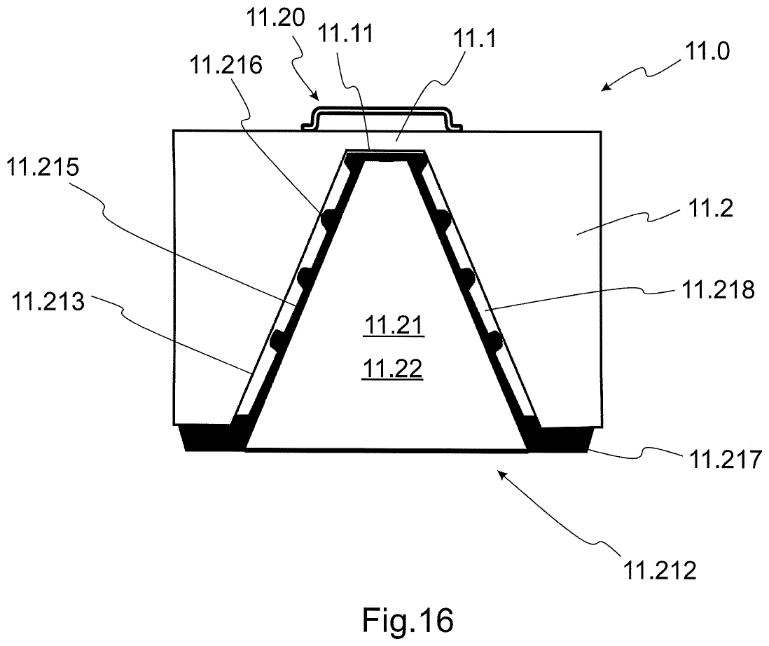

FIG. 16 shows a further embodiment of a pressure measuring cell 11.0 with a liner insert 11.215 and a cap 11.20. The inner surface 11.213 of the support body 11.2 comprises a conical profile, similar to the embodiment shown in FIG. 15. A liner insert 11.215 is arranged in the cavity 11.21 to cover the inner surface 11.213 of the support body 11.2 forming the side wall of the cavity 11.21. The liner insert 11.215 comprises outer ribs 11.216 which abut on the even inner surface 11.215 of the support body 11.2 such that buffer chambers 11.218 filled with air are arranged between the liner insert 11.215 and the inner surface 11.213 of the support body 11.2. The outer ribs 11.216 therefore serve as spacer elements for generating the buffer chambers 11.218. In case of freezing of the measurement medium, the buffer chambers 11.218 may be compressed such that the increase in measurement volume can be compensated for. The liner insert 11.215 further comprises a flange 11.217 which abuts on an outer transverse surface of the support body 11.2 at the second side 11.212 of the cavity 11.21. The liner insert 11.215 has a conical shape and forms a side wall of the trough-shaped chamber 11.22.

Further, the liner insert 11.215 also covers the first surface 11.11 of the membrane 11.1 in order to prevent the measurement medium, such as a urea-water solution to creep into the buffer chambers 11.218. The liner insert 11.215 is made of a urea-resistant plastics with a sufficient rigidity to withstand the fluid pressure of the measurement medium before freezing. Therefore, the liner insert 11.215 preferably exhibits a larger rigidity than the liner insert 10.215 shown in FIG. 15. Furthermore, the liner insert 11.215 preferably has a lower roughness than the inner surface 11.213 of the support body 11.2.

1. A metal pressure measuring cell for absolute pressure sensing, comprising a metal base body a membrane and a support body, the membrane comprising a first surface and a second surface, the support body comprising a cavity which is transversely delimited by an inner surface of the support body and axially delimited at a first side by the first surface of the membrane and open at a second side opposite to the first side to form a trough-shaped chamber for accommodating a measurement medium, the pressure measuring cell further comprising a cap mounted on the base body and covering the second surface of the membrane such that a hermetically closed pressure reference volume is formed between the cap and the second surface of the membrane, wherein the cap is made of metal.

2. The pressure measuring cell according to claim 1, wherein the cap has an inner transverse area which is equal to the area of the membrane or larger than the area of the membrane.

3. The pressure measuring cell according to claim 1, wherein the coefficients of expansion of the base body and the cap are essentially equal.

4. The pressure measuring cell according to claim 1, wherein the base body and/or the cap are made of a duplex stainless, a ferritic or an austenitic steel.

5. The pressure measuring cell according to one of the claim 1, wherein the cap has a circular cross-section.

6. The pressure measuring cell according to claim 1, wherein the cap comprises a transverse cover portion, a side wall and a flange transversely adjoining the side wall, wherein the cap is mounted on the base body by the flange.

7. The pressure measuring cell according to claim 1, wherein the cap is mounted on the base body by soldering.

8. The pressure measuring cell according to claim 7, comprising a solderable metallic layer arranged between the base body and the cap and surrounding the second surface of the membrane.

9. The pressure measuring cell according to claim 8, wherein the solderable metallic layer is made of AgPd.

10. The pressure measuring cell according to claim 8, comprising an intermediate insulating layer arranged between the base body and the metallic layer and surrounding the second surface of the membrane.

11. The pressure measuring cell according to claim 1, wherein the pressure in the reference volume is below 20 mbar.

12. The pressure measuring cell according to claim 1, wherein the inner surface of the support body is shaped such that a transverse diameter (D) of the trough-shaped chamber monotonously decreases from the second side of the cavity towards the first side of the cavity.

13. The pressure measuring cell according to claim 12, wherein the inner surface of the support body adjoins the first surface of the membrane with a slope.

14. The pressure measuring cell according to claim 12, wherein the inner surface of the support body comprises one or more conical profile sections.

15. The pressure measuring cell according to claim 12, wherein the inner surface of the support body comprises a conical profile extending from the second side of the cavity to the first side of the cavity.

16. The pressure measuring cell according to claim 12, wherein the inner surface of the support body comprises one or more concave sections.

17. The pressure measuring cell according to claim 12, wherein the inner surface of the support body comprises one or more convex sections.

18. The pressure measuring cell according to claim 12, wherein the inner surface of the support body comprises a parabolic profile extending from the second side of the cavity to the first side of the cavity.

19. The pressure measuring cell according to claim 1, wherein the trough-shaped chamber is an empty space configured to solely accommodate the measurement medium.

20. The pressure measuring cell according to claim 1, wherein the membrane and the support body are formed as an integral part such that the trough-shaped chamber configured to accommodate the measurement medium is formed by the integral part.

21. A method of manufacturing the pressure measuring cell according to claim 1, comprising the steps of:
providing a base body made of a metal with a membrane and a support body;
arranging an intermediate insulating layer on the base body to surround the membrane;
forming a solderable metallic layer on the intermediate insulating layer to surround the membrane;
mounting a cap made of a metal on the base body by soldering a mounting portion of the cap, onto the solderable metallic layer.

22. The method according to claim 21, wherein the cap is manufactured by punching and stamping of a sheet metal.

23. The method according to claim 21, wherein the mounting portion of the cap is soldered onto the metallic layer by vacuum soldering.

24. The method according to claim 21, wherein the cap is made of a duplex stainless steel, a ferritic or an austenitic steel.

25. A pressure transducer configured to measure pressure of a measurement medium with a density anomaly, comprising a pressure measuring cell according to claim 1.

26. The pressure transducer according to claim 25, wherein the trough-shaped chamber is an empty space for accommodating solely the measurement medium.

27. A dosing unit for dosing an exhaust gas reduction medium, comprising a pressure transducer according to claim 25.
